(19) United States
(12) Patent Application Publication
(10) Pub. No.: US 2015/0207950 A1
(43) Pub. Date: Jul. 23, 2015

(54) IMAGE PROCESSING APPARATUS WHICH IMPROVES USER'S CONVENIENCE, CONTROL METHOD THEREOF AND STORAGE MEDIUM

(71) Applicant: CANON KABUSHIKI KAISHA, Tokyo (JP)

(72) Inventor: Tomohiro AKIBA, Tokyo (JP)

(21) Appl. No.: 14/596,714

(22) Filed: Jan. 14, 2015

(30) Foreign Application Priority Data
Jan. 21, 2014 (JP) 2014-008618

(51) Int. Cl. H04N 1/00; H04N 1/21

(52) U.S. Cl. CPC H04N 1/00896; H04N 1/21; H04N 2201/0094; H04N 2201/214

(57) ABSTRACT

An image processing apparatus can improve convenience of a user. A storage unit stores data therein. A measuring unit measures the data transfer speed to the storage unit. A comparing unit compares the measured data transfer speed with a predetermined value. A determining unit determines whether or not transition to a power saving mode is possible according to a result of comparison. If the measured data transfer speed is equal to or lower than the predetermined value, the determining unit determines that the transition to the power saving mode is impossible.

### BACKGROUND OF THE INVENTION

1. Field of the Invention

The present invention relates to an image processing apparatus, a control method thereof and a storage medium, and more particularly, to an image processing apparatus which maintains functions even if an operation speed of a storage device used for data processing fluctuates, a control method thereof and a storage medium.

2. Description of the Related Art

As a conventional device using an SSD (Solid State Drive), a device which determines a life of the SSD from a fluctuation in a data transfer speed of the SSD is known. For example, Japanese Laid-Open Patent Publication (Kokai) No. 2012-234321 discloses measuring read/write speeds of data from/to an SSD, determining a degree of degradation in the SSD based on decreases in the read/write speeds, and utilizing a decrease in the data transfer speed of the SSD to determine the life of the SSD.

However, there is a problem that it is impossible to determine the life of the SSD accurately since even a temporal decrease in the data transfer speed during operation of the SSD possibly causes a determination of the end of life of the SSD.

Meanwhile, in a typical SSD, processing called garbage collection for organizing data using a preliminary region or a free region is performed according to an amount of written data.

While the above-described garbage collection operates, the data transfer speed of the SSD decreases. For example, even if a write speed at normal times is 200 MB/S, the write speed decreases to 70 MB/S while the garbage collection operates, and returns to 200 MB/S after the garbage collection is finished. While the garbage collection irregularly occurs when the amount of data written in the SSD increases, whether or not the garbage collection operates can be only determined from outside of the SSD based on whether or not the data transfer speed of the SSD temporarily decreases.

An image processing apparatus such as a multifunction printer (MFP) has a power saving mode (or a sleep mode) as one power state. During the power saving mode, the supply of power to most of components of the device including the SSD is limited. When the power state returns to a normal mode according to user operation or the like, the power is supplied to continue processing.

However, if the garbage collection operates in the normal mode when the power state transitions from the normal mode to the power saving mode, the operation of the garbage collection resumes when the power state returns from the power saving mode to the normal mode afterward. Owing to this, the SSD is prompted to operate in a state where the transfer speed decreases. Meanwhile, a lot of jobs using the SSD are executed immediately after the power state returns to the normal mode. As a result, the jobs are executed in a state where the data transfer speed of the SSD decreases. This causes a problem that the image processing apparatus cannot exert its original performance or an error occurs due to time-out.

### SUMMARY OF THE INVENTION

The present invention provides an image processing apparatus which can improve convenience of a user by preventing a decrease in a data transfer speed of an SSD due to operation of garbage collection when a power state transitions from a power saving mode to a normal mode and suppressing degradation of performance of the image processing apparatus after the power state returns to the normal mode, and a control method thereof and a storage medium.

Accordingly, the present invention provides an image processing apparatus provided with a storage unit storing therein data, the image processing apparatus comprising a measuring unit configured to measure a speed for transferring the data to the storage unit, a comparing unit configured to compare the transfer speed measured by the measuring unit with a predetermined value, and a determining unit configured to determine whether or not transition to a power saving mode is possible according to a result of comparison by the comparing unit, wherein if the measured transfer speed is equal to or lower than the predetermined value, the determining unit determines that the transition to the power saving mode is impossible.

According to the present invention, it is possible to improve convenience of the user by preventing decrease in the data transfer speed of the SSD due to operation of the garbage collection when the power state transitions from the power saving mode to the normal mode and suppressing degradation of performance of the image processing apparatus after the power state returns to the normal mode.

Further features of the present invention will become apparent from the following description of exemplary embodiments (with reference to the attached drawings).

### BRIEF DESCRIPTION OF THE DRAWINGS

FIG. 1 is a block diagram showing a schematic configuration of an image processing apparatus according to an embodiment of the present invention.

FIG. 2 is a flowchart showing SSD transfer speed measuring processing in the image processing apparatus of FIG. 1.

FIG. 3 is a flowchart showing sleep mode transition judgment processing in the image processing apparatus of FIG. 1.

### DESCRIPTION OF THE EMBODIMENTS

Embodiments of the present invention will be described in details below with reference to the drawings.

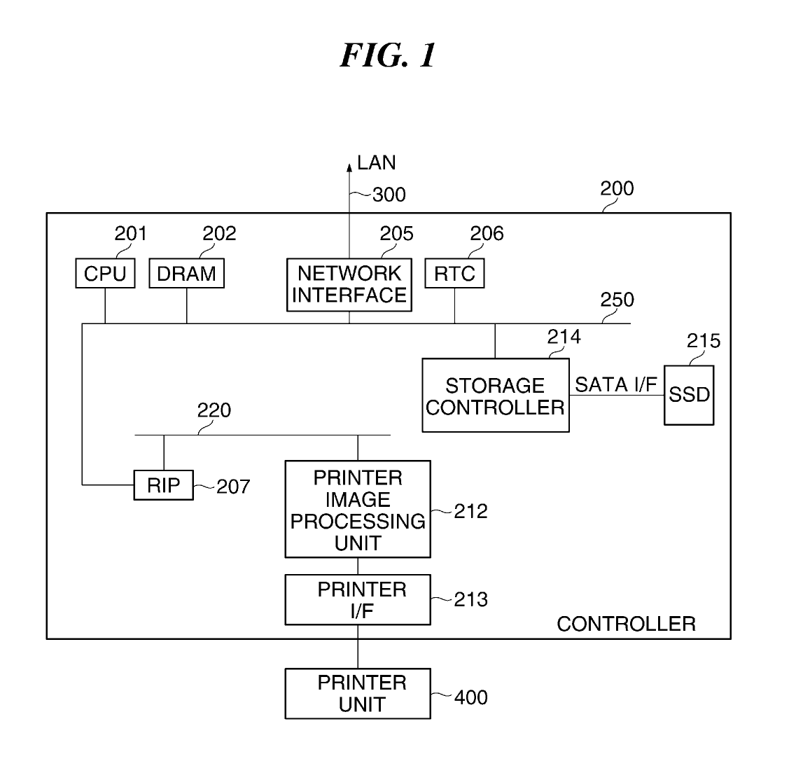

FIG. 1 is a block diagram showing a schematic configuration of an image processing apparatus according to an embodiment of the present invention.

In FIG. 1, the image processing apparatus includes a controller 200 for controlling image processing and a printer unit 400 (printer engine) that performs printing on a recording sheet. A printing method executed by the printer unit 400 may be any printing method. Further, the image processing apparatus may be a printer having a single function or may be a multifunction printer having a plurality of functions, and, for example, may be a fax machine.

The controller 200 receives PDL data which is print data at a network interface 205 via a LAN 300. The received PDL data is temporarily written in a DRAM 202 and written in an SSD 215 via a storage controller 214.

The PDL data written in the SSD 215 is converted into a display list by a CPU 201, and the display list is written in the SSD 215 again via the DRAM 202. The display list written in the SSD 215 is read and transmitted to a RIP circuit 207 and converted into raster data, and the raster data is written in the SSD 215 again.

Next, the written raster data is read from the SSD 215 via an internal bus 250, and the raster data passes through the RIP circuit 207 and is delivered to a printer image processing unit 212 via an image bus 220. The raster data is subjected to concentration processing, screen processing or the like, at the printer image processing unit 212, and the processed raster data is sent out to the printer unit 400 via a printer I/F 213.

The controller 200 switches between power supply and power cutoff to each component of the device using a power supply control circuit (not shown). It is thereby possible to realize a normal mode in which power is supplied to the whole image processing apparatus, a power saving mode (or a sleep mode) in which power is supplied only to the DRAM 202 and the network interface 205 or the like. An RTC (Real Time Clock) 206 executes time measurement under the conditions (for example, in the power saving mode) that power supply to the system is limited, and operates under such conditions.

Next, SSD data transfer speed measurement processing in the image processing apparatus in FIG. 1 will be explained.

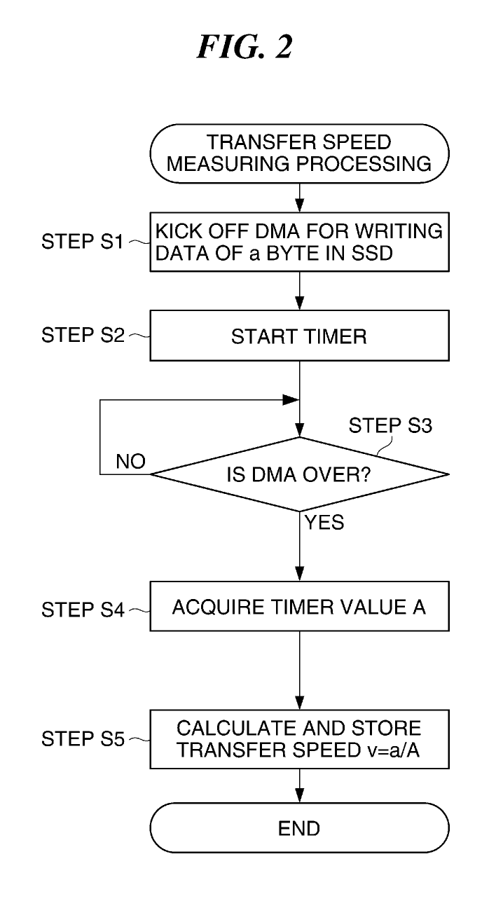

FIG. 2 is a flowchart showing SSD data transfer speed measurement processing in the image processing apparatus of FIG. 1. This processing is executed every time the SSD 215 is accessed. It should be noted that this processing is implemented by the CPU 201 by executing a read program.

First, DMA (Direct Memory Access) for transferring (writing) data having a data size a [Bytes] to the SSD 215 is kicked off (started) (step S1).

A timer is then started using the RTC 206 (step S2).

Subsequently, it is determined whether or not the DMA is over (step S3), if the DMA is over, the flow proceeds to step S4.

A timer value A is then acquired from the RTC 206 (step S4). This timer value A means a period required for transferring data having the data size a to the SSD 215.

Next, a transfer speed v to the SSD is calculated from the data size a [Bytes] and the timer value A acquired in step S4, and stored in the DRAM 202 (step S5). The transfer speed v to the SSD is calculated using the following Equation (1). It should be noted that the transfer speed v stored in the DRAM 202 is updated through the above-described processing every time the SSD 215 is accessed.

Transfer speed v[Byte/sec]=a[Bytes]/A[sec] (1)

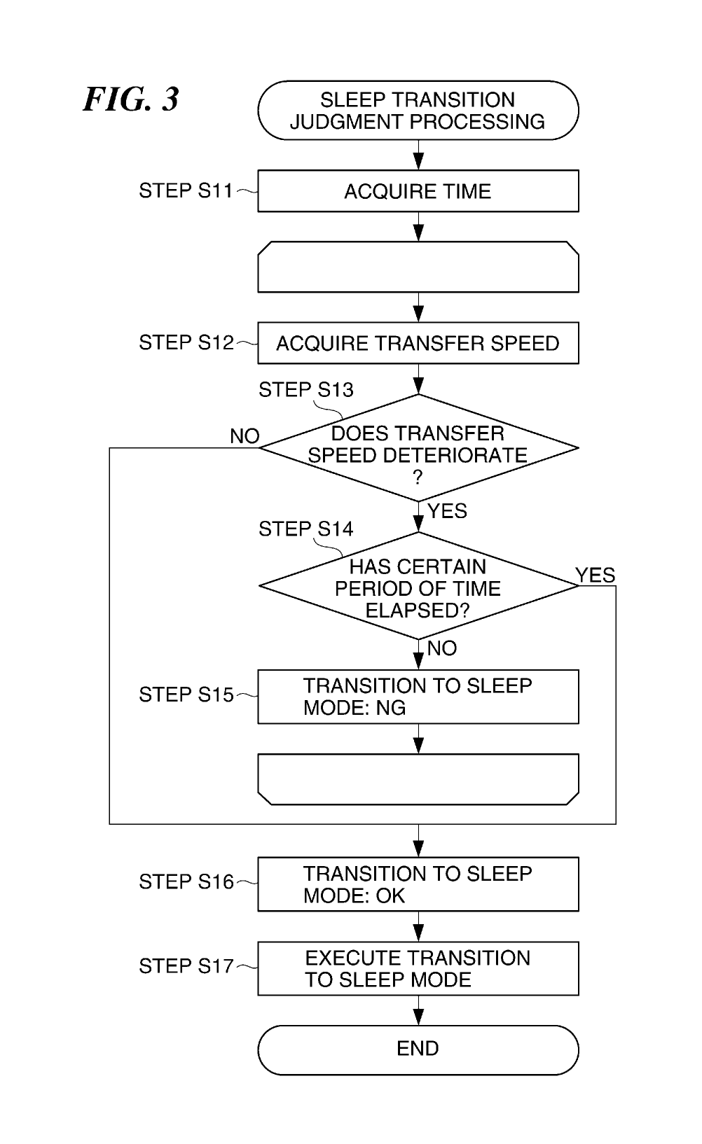

FIG. 3 is a flowchart showing sleep mode transition judgment processing in the image processing apparatus of FIG. 1. This processing is regularly executed while the operating state of the image processing apparatus is the normal mode. It should be noted that this processing is implemented by the CPU 201 by executing the read program.

First, current time is acquired (step S11). The current time may be directly acquired from the RTC 206, or may be a value counted using software after a value is acquired from the RTC 206 in advance.

Next, the transfer speed v which is calculated and stored in the DRAM 202 in step S5 of FIG. 2 is acquired (step S12).

The acquired transfer speed v is then compared with a predetermined value (step S13). If it is determined that the transfer speed v is equal to or lower than the predetermined value, it is determined that the data transfer speed of the SSD decreases because garbage collection operates, and the flow proceeds to step S14. On the other hand, if it is determined that the transfer speed v is not equal to or lower than the predetermined value from the comparison result in step S13, it is determined that the data transfer speed of the SSD does not decrease, and the flow proceeds to step S16. It should be noted that the predetermined value (reference transfer speed) which is to be compared with the transfer speed v is set in advance based on the specifications of the SSD or the specifications, settings or the like of the image processing apparatus.

Next, it is determined whether a certain period of time has elapsed since the data transfer speed of the SSD decreases by comparing the time acquired in step S11 with the current time acquired from the RTC or the like. If the certain period of time has elapsed, it is determined that the data transfer speed of the SSD decreases over a long period of time due to factors other than garbage collection, and the flow proceeds to step S16. On the other hand, if the certain period of time has not elapsed, the flow proceeds to step S15.

A case where the certain period of time has not elapsed corresponds herein to a case where the data transfer speed decreases because the garbage collection operates. If the power state transitions from the normal mode to the power saving mode at this time, when the power state returns from the power saving mode to the normal mode afterward, the operation of the garbage collection resumes and the SSD is prompted to operate in a state where the transfer speed decreases. This results in execution of jobs in a state where the data transfer speed of the SSD decreases in the image processing apparatus. To address this, in step S15, if the certain period of time has not elapsed, that is, if the data transfer speed decreases because the garbage collection operates, it is determined that transition to the power saving mode is impossible, and the flow returns to step S12.

Meanwhile, a case where the certain period of time has elapsed corresponds to a case where the data transfer speed decreases while the garbage collection does not operate. Therefore, even if the power state transitions from the normal mode to the power saving mode at this time and the power state returns from the power saving mode to the normal mode afterward, the operation of the garbage collection is not resumed and jobs are not executed in the image processing apparatus in a state where the transfer speed of the SSD decreases. Owing to this, it is determined that transition to the power saving mode is possible.

Next, after the processing in step S16 is executed, processing for transition to the power saving mode is performed (step S17), and the processing ends. It should be noted that there is a case where even if it is determined in step S16 that the transition to the power saving mode is possible, the power state may not transition to the power saving mode as long as other determination conditions are not met because there are a plurality of conditions to determine whether or not transition to the power saving mode is possible.

As described above, in the present embodiment, transition to the power saving mode is prevented when the data transfer speed of the SSD temporarily decreases because the garbage collection operates, and the power state transitions to the power saving mode after the operation of the garbage collection ends and the data transfer speed of the SSD returns to the normal speed. That is, the data transfer speed of the SSD is measured at appropriate timing in the image processing apparatus. If the data transfer speed of the SSD is equal to or lower than a predetermined transfer speed, it is determined that the garbage collection operates. At this time, transition to the power saving mode is prevented.

In the present embodiment, the transfer speed of the SSD is measured by transferring data of a predetermined size to the SSD and measuring a period required for completing transfer. Therefore, it is not necessary to newly provide hardware for measuring the transfer speed of the SSD, and it is possible to realize processing of measuring the transfer speed only through the processing using software.

As described above, in the present embodiment, a control is exerted such that transition to the power saving mode is prevented when the transfer speed of the SSD temporarily decreases because the garbage collection operates, and the power state transitions to the power saving mode after the transfer speed of the SSD returns to the normal speed. It is thereby possible to improve user's convenience by preventing the decrease in the data transfer speed of the SSD due to the operation of the garbage collection when the power state transitions from the power saving mode to the normal mode and preventing degradation in performance of the image processing apparatus after the power state returns to the normal mode.

It should be noted that while, in the above-described embodiment, it is described that the image processing apparatus may be a printer having a single function or may be a multifunction printer having a plurality of functions, or may be a FAX machine or the like, the image processing apparatus is not limited thereto.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blue-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-008618, filed Jan. 21, 2014, which is hereby incorporated by reference wherein in its entirety.

What is claimed is:

1. An image processing apparatus comprising:
a determining unit configured to determine whether or not a garbage collection processing is performed on data stored in a storage unit; and
a control unit configured to control the image processing apparatus such as not to transit to a power saving mode if the determining unit determines that the garbage collection processing is performed.

2. The image processing apparatus according to claim 1, wherein the garbage collection processing is processing for organizing the stored data using a free region of the storage unit.

3. An image processing apparatus provided with a storage unit storing therein data, the image processing apparatus comprising:
a measuring unit configured to measure a speed for transferring the data to the storage unit;
a comparing unit configured to compare the transfer speed measured by the measuring unit with a predetermined value; and
a determining unit configured to determine whether or not transition to a power saving mode is possible according to a result of comparison by the comparing unit,
wherein if the measured transfer speed is equal to or lower than the predetermined value, the determining unit determines that the transition to the power saving mode is impossible.

4. The image processing apparatus according to claim 3, wherein the measuring unit calculates the transfer speed from a size of the data transferred to the storage unit and a period required for transferring the data.

5. A control method for an image processing apparatus provided with a storage unit storing therein data, the control method comprising:
a measuring step of measuring a speed for transferring the data to the storage unit;
a comparing step of comparing the transfer speed measured in the measuring step with a predetermined value; and
a determining step of determining whether or not transition to a power saving mode is possible according to a result of comparison in the comparing step,
wherein, in the determining step, if the measured transfer speed is equal to or lower than the predetermined value, it is determined that the transition to the power saving mode is impossible.

6. A control method for an image processing apparatus comprising:
a determining step of determining whether or not a garbage collection processing is performed on data stored in a storage unit; and
a control step of controlling the image processing apparatus such as not to transit to a power saving mode if it is determined in the determining step that the garbage collection processing is performed.

7. A computer-readable non-transitory storage medium storing a program for causing a computer to execute a control method for an image processing apparatus, the control method comprising:
a measuring step of measuring a speed for transferring the data to the storage unit;
a comparing step of comparing the transfer speed measured in the measuring step with a predetermined value; and
a determining step of determining whether or not transition to a power saving mode is possible according to a result of comparison in the comparing step,
wherein, in the determining step, if the measured transfer speed is equal to or lower than the predetermined value, it is determined that the transition to the power saving mode is impossible.
